(19) United States
(12) Patent Application Publication
(10) Pub. No.: US 2010/0319508 A1
(43) Pub. Date: Dec. 23, 2010

(54) DEVICE FOR DISPENSING PAPER SECTIONS

(76) Inventor: Hans Georg Hagleitner, Zell Am See (AT)

Correspondence Address: LERNER GREENBERG STEMER LLP, P O BOX 2480, HOLLYWOOD, FL, 33022-2480, US

(21) Appl. No.: 12/821,270

(22) Filed: Jun. 23, 2010

(30) Foreign Application Priority Data
Jun. 23, 2009 (AT) A 966/2009
Jun. 23, 2009 (AT) A 967/2009

(51) Int. Cl. B26D 5/20; B26D 1/56

(52) U.S. Cl. 83/62.1; 83/331

(57) ABSTRACT

An apparatus for dispensing sections of a paper web has a cutting roller and an outlet-side pressing roller that presses the paper web onto the cutting roller. The pressing roller is provided with a drive, in particular a motorized drive and the pressing roller for its part drives the cutting roller.

### CROSS-REFERENCE TO RELATED APPLICATION

This application claims the priority, under 35 U.S.C. §119, of Austrian patent applications Nos. A 966/2009, filed Jun. 23, 2009, and A 967/2009, filed Jun. 23, 2009; the prior applications are herewith incorporated by reference in their entirety.

### BACKGROUND OF THE INVENTION

### Field of the Invention

The invention relates to an apparatus for dispensing sections of a paper web, having a cutting roller for cutting the paper web and having a pressing roller, via which the paper web is pressed onto the cutting roller.

Relatively old paper dispensers, in particular for paper hand towels or the like, usually have a manual drive which either comprises an outer actuating element, such as a pivoting lever or a crank, or is operated by the user pulling on the protruding end of the paper web. In the latter case, above all, the conveying roller, over the circumference of which the paper web runs, preferably contains a knife device which cuts the paper web in a manner which is driven by the rotating conveying roller. However, the paper web can also be perforated, with the result that a knife device is unnecessary, or a tear-off edge or serration is provided on the dispenser housing. In these cases, the conveying roller serves only to advance the corresponding length of the paper web.

Relatively new paper dispensers have a motorized drive and are usually set in motion by the user contactlessly. In such a dispenser, the options suggested above are also conceivable and known.

Since the motorized drive is disadvantageous in the case of a paper jam or a power blackout or brownout and the dispensing of paper can be made more difficult, or even impossible, U.S. patent application publication US 2007/0079684 A describes a paper dispenser, the conveying roller of which can be driven by motor or, in an emergency, manually. For this purpose, a spur gearwheel is arranged on the cutting roller, into which spur gearwheel both the manual drive and the motorized drive constantly engage, in each case with a free wheel. As a result, the length of the cutting roller is greater than necessary and causes the paper dispenser to be widened, which is disadvantageous in spatially constricted localities.

### SUMMARY OF THE INVENTION

It is accordingly an object of the invention to provide a device for dispensing sections of paper which overcomes the above-mentioned disadvantages of the heretofore-known devices and methods of this general type and which provides for a solution to the space problem and which reduces the width of paper dispensers, in particular paper hand towel dispensers, by shortening an axial length of the cutting roller in the apparatus.

With the foregoing and other objects in view there is provided, in accordance with the invention, an apparatus for dispensing sections of a paper web, comprising:

a cutting roller for cutting the paper web;

an outlet-side pressing roller disposed to press the paper web onto said cutting roller; and

a drive connected to drive said pressing roller, with said drive driving said pressing roller and said pressing roller driving said cutting roller via the paper web.

In a preferred embodiment of the invention, the drive is a motorized drive.

In other words, the objects of the invention are achieved in a simple way. A drive, in particular a motorized drive, is provided for the drive roller which, in turn, drives the cutting roller. In this way, sufficient space is provided for drive elements, since the pressing roller can at least be somewhat shorter than the cutting roller, and is anyway preferably restricted to two or three pressing rollers which are spaced apart from one another and are also spaced apart from the ends of the cutting roller. The drive roller which is shorter in a preferred embodiment can be provided, at least at one end, with a drive gearwheel or the like which meshes with the manual or motorized drive.

In accordance with an added feature of the invention, the cutting roller is composed of two half rollers, cam tracks which are fixed to the apparatus being provided in the interior for controlling a knife which can be moved in and out in the cutting roller. This embodiment makes it possible to mount the cutting roller on the end side on carrying journals outside the guide tracks, with the result that the overall length is also not increased as a result.

In order for it to be possible to determine one exact revolution of the cutting roller despite a possible slip in the frictional connection between the pressing roller and the cutting roller, the cutting roller is provided, in a further preferred embodiment, with a marking or the like which can be detected by an external sensor, in order to stop the motorized drive of the pressing roller after one complete revolution of the cutting roller.

Other features which are considered as characteristic for the invention are set forth in the appended claims.

Although the invention is illustrated and described herein as embodied in a paper dispenser for dispensing paper sections from a paper web, it is not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a perspective view of a cutting device with blade guide;

FIGS. 2-6 respectively show turned diagrammatic end views of the cutting device;

FIG. 7 shows a diagrammatic end view showing four different positions of the blade movement;

FIG. 8 shows a perspective view of a blade carrier; and

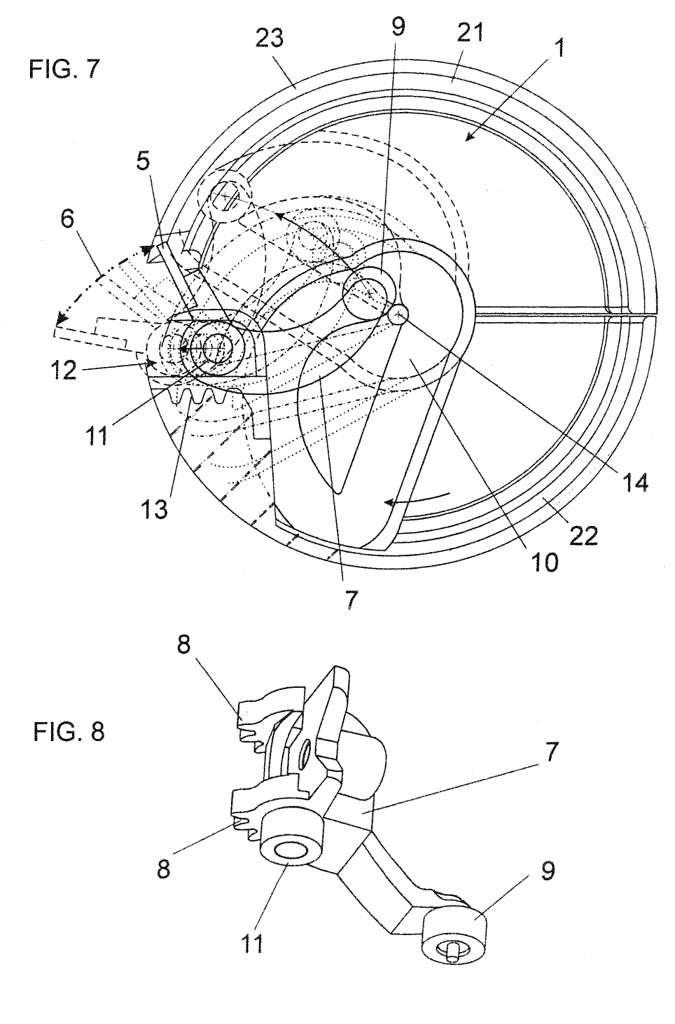

FIG. 9 is a diagrammatic perspective view of a partly broken-away paper dispenser.

### DETAILED DESCRIPTION OF THE INVENTION

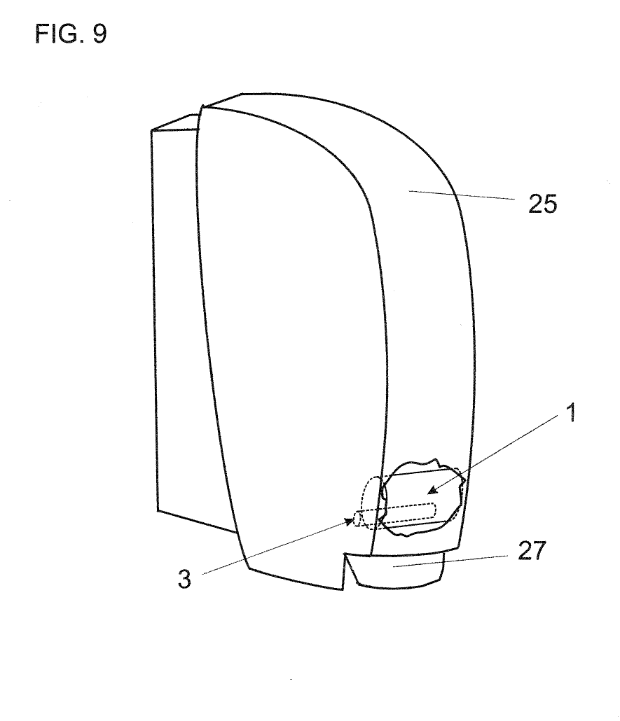

Referring now to the figures of the drawing in detail, FIG. 9 shows an exemplary embodiment in the form of a device for the distribution of paper portions, for example a paper towel dispenser. The device has a housing 25 in which a roll of paper and preferably also a reserve roll are disposed. A cutting roller 1 is provided in the lower region. The cutting roller 1 is composed of two semi-rollers 21, 22 and is indirectly drivable by motor or manually. An actuating element 27 for manual drive is arranged at the underside. If the manual drive is only provided as an auxiliary drive a motor drive can be disconnected at the same time.

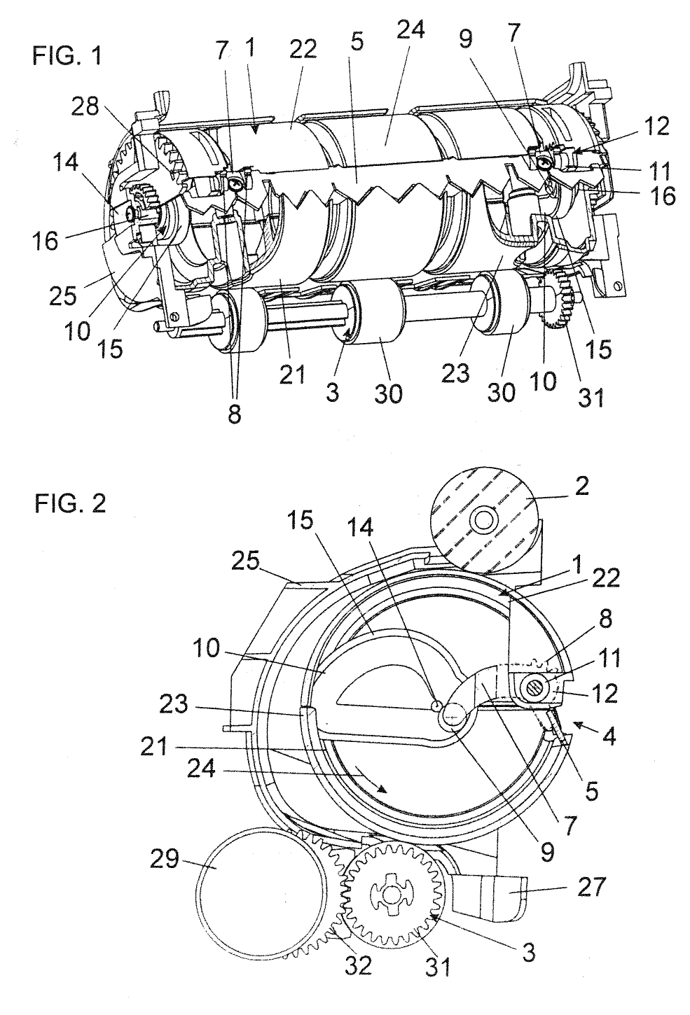

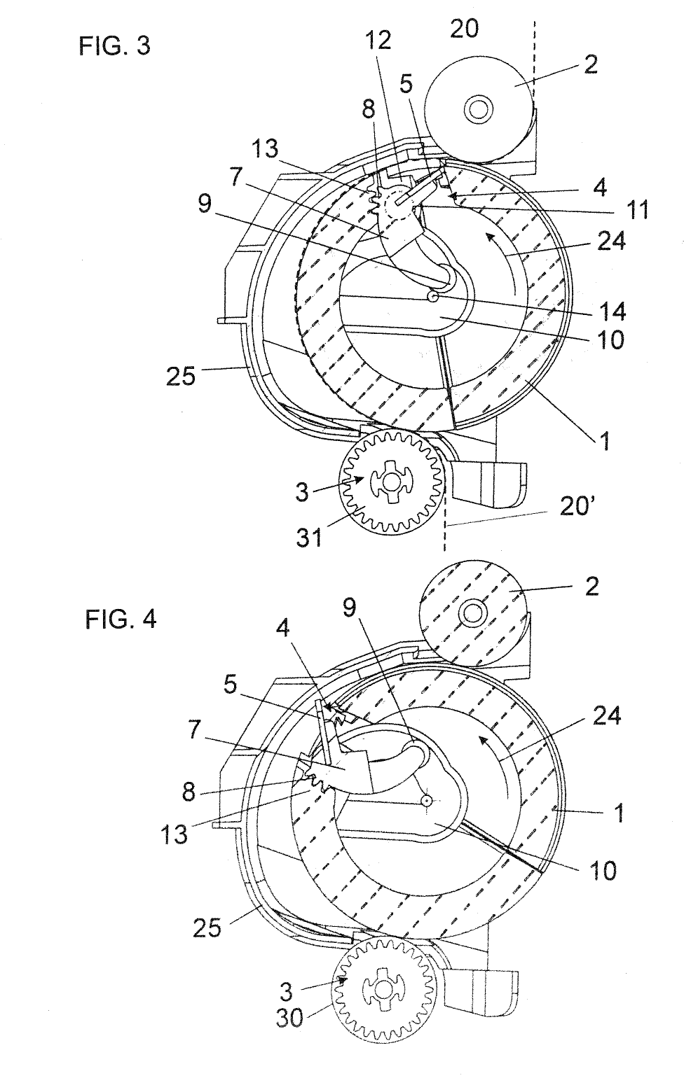

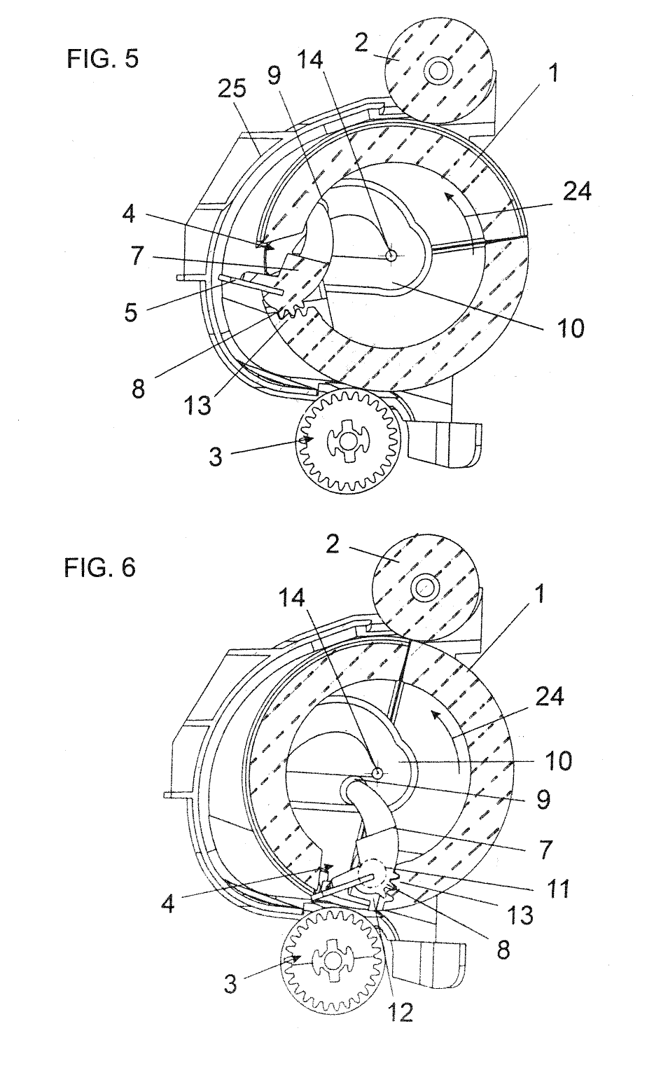

The uncut paper web 20 (see, FIG. 3) is fed from a supply roll by way of an entry pressure roller 2 to the cutting roller 1 rotatable about an axis 14. The paper web 20 passes well around half the periphery of the cutting roller and passes over the exit pressure roller 3 to the removal location. As can be seen from FIGS. 1 and 2 the exit pressure roller 3 is provided with a gear 31 which is driven by way of an intermediate gear 32 with an electric motor 29 only diagrammatically shown in FIG. 2. The exit pressure roller 3 has axially spaced pressure ring members 30 which press against the cutting roller 1 and convey the paper web 20. The pressure force applied by the exit pressure roller 3 and the encirclement around the cutting roller 1 over half the periphery thereof ensures the rotary movement of the cutting roller 1 which is thus only indirectly driven by the electric motor 29. The paper portions 20′ are cut off the paper web 20 by means of an especially toothed blade 5 (FIG. 1). For that purpose, during the rotation of the cutting roller 1, the blade 5 which also rotates therewith is pushed out of the cutting roller 1 through a slot 4 extending parallel to the axis 14, in which case the blade cutting edge moves along a path 6 which is curved in the direction of rotation of the roller (see FIG. 7) in leading relationship with respect to the periphery of the cutting roller 1. Depending on the respective elasticity, stretchability and strength the paper web 20 is lifted to a greater or lesser extent off the cutting roller 1 and in so doing is increasingly tensioned between the entry pressure roller 2 and the cutting roller 1 on the one hand and the exit pressure roller 3 and the cutting roller 1 on the other hand by the blade teeth which are pushed out of the cutting roller 1 in opposite relationship to the direction of rotation 24 of the roller, until the teeth cut thereinto, in which case the exit angle of the blade changes and the teeth penetrate completely into the paper web 20. The blade guide required for that purpose includes a carrier which has two side portions 7 which are reciprocatingly displaceable in the slot 4 of the cutting roller 1 and which are guided in rotational relationship along two end, non-circular cam paths 10 and to which the blade 5 is fixed projecting approximately at a right angle. The two side portions 7 are of mirror image configurations. At the inner end each side portion 7 has a first guide element 9, in particular a rotatably mounted roller, which engages into the cam path 10 which is provided on an element 15 that is mounted within the cutting roller 1 and non-rotatably connected to the side wall of the housing 25. Thereby, the total axial length of the cutting roller 1 and its mounting that cause the width of the housing 25 is as short as possible.

As mentioned the cutting roller 1 preferably includes two semi-rollers 21, 22 which after insertion of the cutting mechanism are joined together, for example by screw means, in which case the semi-rollers 21, 22 supplement each other at the ends to constitute bearing bushes mounted on trunnions 16, to which the elements 15 are fixed. In that way the cam paths 10 are provided in the interior of the cutting roller 1.

Each side portion 7 has a second pin-shaped guide element 11 which engages into a substantially straight or slightly curved displacement guide 12 provided in the form of a guide path at one of the two semi-rollers 21, 22 in such a way that it extends in the slot 4. Each side portion 7 is further provided at the end nearer the second guide element 11 with a tooth assembly 8 which for example has three teeth arranged concentrically relative to the pin-shaped guide element 11. The teeth engage into a tooth assembly 13 provided at a further guide surface of the two semi-rollers 21, 22 and delimits the slot 4 of the assembled cutting roller 1 at one side. Preferably the tooth assemblies 8, 13, which mesh with one another are provided in mutually parallel doubled relationship to increase the guidance and stability of the two side portions 7 of the carrier during the outward and inward movement. When the cutting roller 1 is rotated in the direction of the arrow 24 the two side portions are displaced, as can be seen from FIGS. 2 through 6, by virtue of the non-parallel guidance effect in the cam path 10 and the displacement guide 12 in the slot 4, wherein the two side portions 7 roll in the tooth arrangements 13 and the blade 5 is pivoted outwardly. In that case the blade tips move along the path 6 shown in FIG. 7. There, FIG. 7 shows the blade movement when the cutting roller 1 is held fast and the bearing elements 15 are rotated with the cam paths 10 about the roller axis 14 in the direction of the arrow. The cam path 10 has a portion which embraces somewhat over 180° at the roller axis 14 in concentric relationship therewith so that the blade remains in the retracted position shown in FIG. 2 between the exit pressure roller 3 and the entry pressure roller 2. After passing the entry pressure roller 2 the first guide element 9 passes into a curved portion of the cam path, the spacing of which relative to the roller axis 14 increases whereby the side portions 7 of the carrier are displaced in the guide path 12 and roll in the tooth arrangement 13 so that the blade moves out of the position shown in FIG. 3 into the position shown in FIG. 4 and finally into the position of FIG. 5 in which the blade 5 is furthest extended and pivoted outwardly. In that case the movement of the blade cutting edge is in leading relationship with the rotation of the roller so that cutting of the paper web 20 is ensured after the blade tips penetrate thereinto as the tension in the paper web increases.

The cam path 10 moves out of the position shown in FIG. 5 approximately in a straight line back into the concentric portion (FIG. 6), whereby the blade 5 is retracted again in the remaining 60° of the roller rotation to the exit pressure roller 3. The paper portion 20′ can then be removed at the underside of the housing 25. The drive of the exit pressure roller 3 is effected by motor means and in particular in contact-less mode, in which case the motor 29 and, if necessary, the exit pressure roller 3 can be disconnected for emergency operation by hand. The emergency operation by hand is effected by way of an actuating lever 27 at the lower end of the housing, or by pulling on the projecting end of the paper web, as the case may be. The described blade guide is the same in all cases. The tooth arrangements 8, 13 promote flowing movements of the side portions 7, wherein the rolling off movement necessarily arises out of the non-parallel double guidance effect in the cam path 10 and the displacement guide 12.

In the illustrated embodiment the blade 5 is respectively held in the end region only at the two side portions 7. To increase stability the two side portions 7 can also have an additional longitudinal connection so that for example the two side portions form side limbs of an approximately U-shaped carrier loop, to which the blade 5 can be secured at a plurality of locations.

The entry pressure roller 2 has a friction-enhancing peripheral surface, in particular a rubber coating formed at least by a plurality of rings.

As already mentioned the blade 5 is toothed to make it easier to cut the paper web so that it firstly digs into the paper with a row of points. The region of the peripheral surface, that follows the slot 4 in the cutting roller 1, is provided with a rubber layer 23 so that after passing the slot 4 the paper web 20 is clamped between the entry pressure roller 2 and the rubber layer 23. As soon as the teeth of the blade 5 have dug into the paper web 20 the tension in the paper web 20 increases. That is additionally further increased as, by virtue of the guidance for the blade 5, the cutting edge thereof issues from the slot 4 in leading relationship with the periphery of the cutting roller 1, that is to say the blade 5 accelerates in comparison with the cutting roller 1.

The exit pressure roller 3 also has a friction-enhancing peripheral surface, in particular a rubber coating formed at least by a plurality of rings. Thereby, as already mentioned, the movement of the blade is effected by the driven exit pressure roller 3 pressing the paper web against the cutting roller 1 as well as pulling forces are applied to the paper web in the conveying direction in order to avoid the end being drawn back when the blade 5 is extended out of the cutting roller.

If the paper web 20 has disadvantageous properties for the cutting effect, that is to say a high tearing strength and a high degree of stretchability, the paper web 20 would not be cut by the outwardly moving blade 5 (FIGS. 4 and 5) in spite of the teeth in the cutting edge, but would be stretched, and the portion of increased length would be laid in folds in the region as far as the exit pressure roller 3 as soon as the blade 5 is retracted again if the rubber layer 23 were to cover the entire periphery of the cutting roller 1 as the paper web 20 would also be clamped to the same extent between the exit pressure roller 3 and the cutting roller 1 and transport it. Compensation would not be possible.

In order now to ensure that the cutting action does not fail to occur and to avoid the paper being crumpled, each half 22 of the cutting roller 1, preceding the slot 4, is provided with a surface whose friction in relation to the paper web 20 is lower than the friction of the surfaces of both pressure rollers 2, 3 and the half 21 of the cutting roller 1, that follows the slot 4. The paper can slide on the surface of lower friction and a portion of increased length of the paper web 20, that occurs due to stretching, is directly compensated as the tensile forces tension the paper web without also rotating the cutting roller 1 until the increased-length portion has been pulled out. In other words the cutting roller 1 rotates only by the corresponding arc-length due to the pull applied to the paper, although a paper portion 20′ which has been increased in size by the stretch is dispensed. Cutting reliability 1 is improved, even if the cutting edge becomes blunter after prolonged use.

In that respect a mechanical paper dispenser can completely cut through the paper web in that way as the user when handling the actuation lever 27 can hold the end of the paper in his hand. In the case of a dispenser which is driven by motor means and in particular in contact-less fashion it is preferably provided that the cut leaves at least a small connecting region between the paper portion 20′ and the paper web 20, which tears without perceptible resistance upon being adopted by the user, but prevents the paper portion 20′ from dropping on to the ground.

In the case of the paper dispenser which is driven contact-lessly by motor means, a marking 28, a permanent magnet or the like is further preferably provided at a location on the roller, to be able to exactly predetermine identical blade positions in each distribution process, which are sensed with suitable sensors on the housing as the length which varies due to stretch cannot be used for exact measurement.

1. An apparatus for dispensing sections of a paper web, comprising:
a cutting roller for cutting the paper web;
an outlet-side pressing roller disposed to press the paper web onto said cutting roller; and
a drive connected to drive said pressing roller, with said drive driving said pressing roller and said pressing roller driving said cutting roller via the paper web.

2. The apparatus according to claim 1, wherein said drive is a motorized drive.

3. The apparatus according to claim 1, wherein said pressing roller has at least two pressing rollers spaced apart from one another in an axial direction.

4. The apparatus according to claim 1, wherein said pressing roller is shorter than said cutting roller and, said pressing roller carries a drive gearwheel at one end thereof, and said drive gearwheel meshes with said drive.

5. The apparatus according to claim 1, which further comprises an inlet-side non-driven pressing roller, and wherein the paper web is guided over approximately one half of a circumferential periphery of said cutting roller from said inlet-side, non-driven pressing roller to said outlet-side pressing roller.

6. The apparatus according to claim 1, wherein said cutting roller is formed of two half rollers, having a slot formed therebetween, and which comprises a slotted guide fixedly mounted in the apparatus for controlling a knife to be moved in and out through said slot in said cutting roller.

7. The apparatus according to claim 6, wherein said cutting roller is formed with an outer face and said outer face has lower friction with respect to the paper web in said half roller lying in front of said slot than the friction in said half roller following said slot.

8. The apparatus according to claim 7, wherein said half roller following said slot carries a rubber coating.

9. The apparatus according to claim 1, wherein said cutting roller is provided with a marking enabling a detection of a complete revolution of said cutting roller.

10. The apparatus according to claim 9, which comprises an external sensor disposed to detect said marking in order to stop a motorized drive after one complete revolution of the cutting roller.
